(19) United States
(12) Patent Application Publication
(10) Pub. No.: US 2011/0282042 A1
(43) Pub. Date: Nov. 17, 2011

(54) OBTAINMENT OF CHITIN FROM SHRIMP WASTE BY MEANS OF MICROWAVE AND/OR AUTOCLAVING IN COMBINATION WITH ORGANIC ACIDS IN A SINGLE STAGE

(75) Inventors: Juan Carlos Contreras Esquivel, Saltillo (MX); Cecilia Balvantin Garcia, Saltillo (MX); Angel Uriel Valdez Peña, San Buenaventura (MX); Claudia Patricia Flores Davila, Saltillo (MX)

(73) Assignee: COYOTEFOODS BIOPOLYMER AND BIOTECHNOLOGY, S.R.L. MI, Saltillo (MX)

(21) Appl. No.: 13/144,582

(22) PCT Filed: Jan. 14, 2010
(86) PCT No.: PCT/MX2010/000004

§ 371 Date: Jul. 14, 2011

(30) Foreign Application Priority Data
Jan. 14, 2009 (MX) MX/A/2009/000505

(51) Int. Cl. C08B 37/08

(52) U.S. Cl. 536/20

(57) ABSTRACT

This invention relates to the development of a new method of production of chitin through employment of a microwave process under pressure and/or autoclave with organic acids. This new method eliminates salts and proteins in a single stage and reduces contamination levels. The chitin obtained has application in the areas of medicine, foods, cosmetics and construction, among others.

### BACKGROUND OF THE INVENTION

Chitin is widely distributed in nature mainly as a structural polysaccharide of the cuticles of all crustaceans and insects, but also found as a component of the cell wall of most fungi. Chitin is a homo-polysaccharide composed of units of 2-acetamide-2-deoxy-D-glucopyranose (N-acetyl-D-glucosamine) linked by β-(1,4). The most available source of chitin is shellfish waste, mainly crabs and shrimp shell. The chitin of crustacean is found naturally associated with proteins, minerals, lipids and pigments. The industrial process of production of chitin consists of three basic steps: demineralization for removing the calcium carbonate; deproteinization to remove proteins, and bleaching to remove pigments. A variety of chemical methods have been developed and proposed for the preparation of chitin. Demineralization is usually performed with HCl at concentrations of 0.275 to 2 M, temperatures from 0-100° C. and times of 1-48 h. The deproteinization is performed with 1 M NaOH at 65-100° C. for 1-72 h, and for bleaching ethanol, acetone or hydrogen peroxide are used. Demineralization and deproteinization are achieved under the following conditions: 15 min at room temperature in 0.24 M HCl and during 24 h in NaOH at a temperature of about 70° C., the former without causing any alteration in the molecular weight or degree of acetylation, respectively.

One of the major drawbacks of traditional chemical processes in the production of chitin is the generation of waste and products that affect the environment. These drawbacks have promoted significant efforts to produce chitin through processes that reduce or eliminate the use and generation of hazardous substances. The proposed processes that eliminate protein and/or salts of shellfish waste are based on using enzyme technology, microbiological, electrochemical, sonochemical or microwave. The use of organic acids, such as citric and acetous were used in the demineralization of calcereous chitin (environment temperature during 30 min) of shellfish waste previously deproteinized with NaOH 1M (95° C./6 h). The lactic acid or acetic acid were used in the demineralization (100° C./1 h) of deproteinized shrimp waste by biotechnological process (120 h) for the production of chitin. The ecologic method of deproteinization of chitin by microwave involves the use of a digester 1% solution (w/v) of saponified vegetable oil, 1% sodium dodecyl sulfate (w/v) and 0.25% sodium carbonate (p/v). The deproteinization of shrimp waste is carried out at 180° C. for 10 to 30 min. Subsequently, the deproteinized material is treated with a solution of calcium chloride dissolved in methanol-water solution.

While there are a variety of methods that can be used for the production of chitin, no attempts have been made to evaluate the combination of pressure, temperature, microwave radiation and organic acids to deproteinize and demineralize in a single stage waste cephalothorax shrimp using organic acids. Deproteinization has been proposed (121° C./15 min) of autoclaved crab waste using 3% NaOH (w/v).

### TECHNICAL FIELD OF THE INVENTION

The chitin of high quality is an important additive in agricultural, nutritional, medical, food products and cosmetics. This invention relates to a method of obtaining high quality chitin from crustaceans waste such as: cephalothorax of shrimp, crab and lobster using pressurized microwave energy in combination with organic acids, preferably citric acid and/or lactic acid. The invention also encompasses the use of autoclave technology in combination with organic acids for the production of chitin.

### BRIEF DESCRIPTION OF FIGURES

FIG. 1 describes the % of weight loss of crustacean waste obtained with different organic acids: lactic, citric and control which is the water against the time the sample subjected to irradiation.

FIG. 2 shows the % of the amount of protein with different organic acids: lactic and citric acids and control which is in this case the water against the time in minutes during which the sample is subjected to irradiation.

FIG. 3 shows the infrared spectrum by Fourier transforms of the cephalothorax of shrimp samples treated with water at different times (10, 20, and 30 minutes).

FIG. 4 shows the infrared spectroscopic comparison of Fourier transforms of materials treated with citric acid for 10, 20 and 30 minutes

FIG. 5 shows the spectrum of Fourier transform infrared materials treated with lactic acid for 10, 20 and 30 minutes.

FIG. 6 shows the spectrum the infrared spectrum of Fourier transforms of commercial chitin, a spectrum close to the abscissa, the next curve is the spectrum obtained in the autoclave process, the following indicate the deproteinized and the last is that of shrimp head flour.

### DESCRIPTION OF THE INVENTION

A process based on the deproteinization and demineralization of crustacean waste is patented, preferably in one stage and using microwave technology under pressure or autoclaving in combination with organic acids for the production of chitin. The stages involved in obtaining chitin are: mixing the selected organic acid with the crustacean remainder, to warm up the mixture by microwave irradiation or autoclaving, to separate the solid phase of the liquid, and to wash the insoluble chitin with distilled water and dry it.

### Example 1

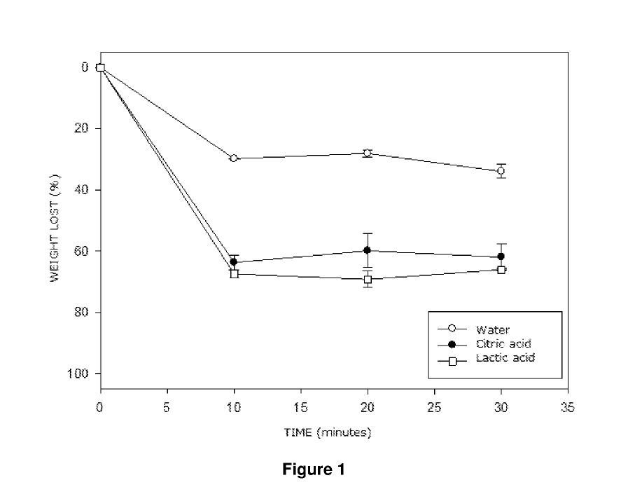

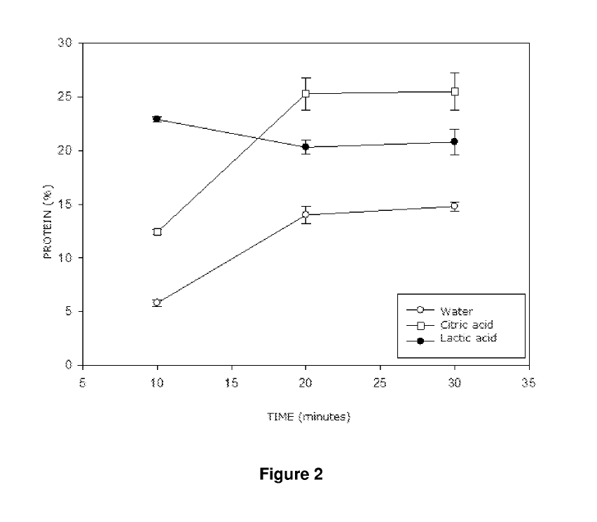

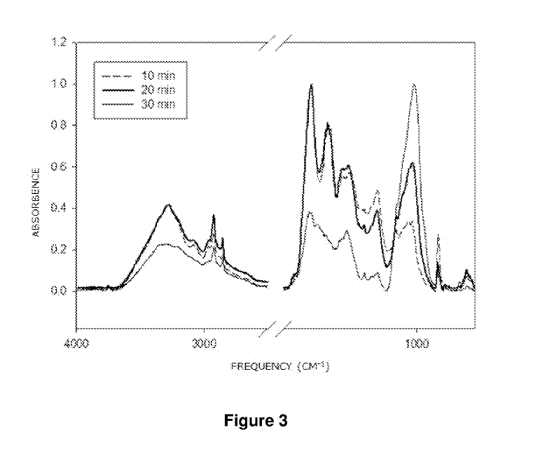

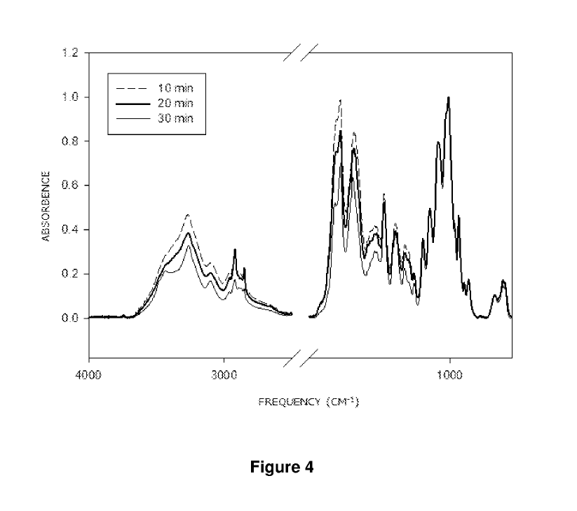

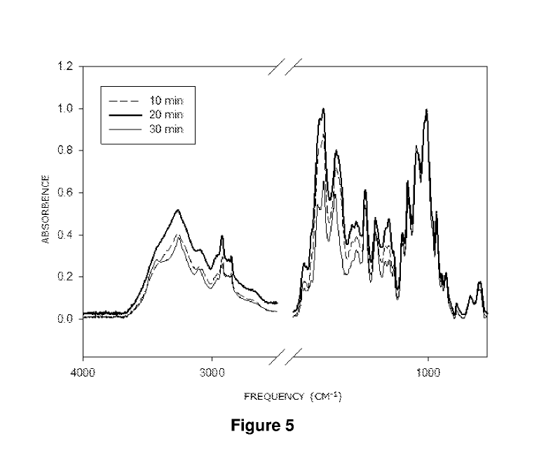

The process for obtaining chitin from a mixture of shrimp waste (shell of the head, abdomen or chest) using microwave radiation which comprises the following steps: Remove the chitin with a chemical agent, preferably a citric acid or lactic acid in combination with the residuum of crustaceans (shrimp shell). This stage consists of irradiating the mixture in step 1 with microwave irradiation. For this purpose the irradiation is divided into six programming steps described in Table 1. In the sixth stage the heating for deproteinization/demineralization of the shrimp head cephalothorax was evaluated at different times (10 to 30 min). After the phase of microwave irradiation, the suspension is filtered. The retained material is considered as chitin and the latter is washed with distilled water under constant agitation at 150 rpm to remove residual organic acids and salts. Chitin is analyzed by infrared spectroscopy by Fourier transforms. FIG. 1 shows the weight loss of the cephalothorax of shrimp on a dry basis after treatment of microwave irradiation at times of 10, 20, and 30 min in the presence of organic acids or water. The use of citric acid also allows the release of proteins and salts to the environment where we find a weight loss of 60% as shown in FIG. 1, using 1 M citric acid under the same conditions of microwave programming operation shown in Table 1. Chitin is analyzed by Fourier transform infrared which can be considered as a commercial crude chitin. This indicates that the microwave-assisted hydrothermal treatment promotes the removal of protein and calcium lactate salts and/or. FIG. 2 shows the release of proteins to the liquid extractor. In the filter proteins and salts remain dissolved. FIG. 3 shows the infrared spectra of samples of cephalothorax treated with water for 10, 20, and 30 min. It can be observed that microwave irradiation promotes the increase of absorption band at 1000 cm⁻¹ indicating the increase of chitin by the loss of protein, and under these conditions the release of salts is not significant. Whereas using citric acid or lactic acid both proteins and salts are released and chitin is obtained in one sole step. FIG. 4 shows the spectroscopic comparison of materials treated with citric acid for 10, 20, and 30 min. 1M citric acid used for 30-minutes, by microwave heating yields a spectroscopic profile of commercial chitin. FIG. 5 shows the same spectroscopic profile of the materials heated by microwave irradiation for 30 minutes using lactic acid. Based on the above description, the difference of this method with those reported in previous work is that the irradiation process of chitin under the present non-contaminating conditions generates a product equal to that reported by traditional methods involving the use of corrosive chemicals such as hydrochloric acid and sodium hydroxide. Moreover, calcium lactate salts and citrate and/or highly water-soluble magnesium and protein greater than 1 kDa are obtained.

TABLE 1
Programming of pressurized microwave
equipment using example 1.

| | Time | Power | Temperature | Pressure | Agitation |
|---|---|---|---|---|---|
| Ramp | (min) | (Watts) | (° C.) | (Bar) | (%) |
| 1 | 1:30 | 500 | 50 | 1 | 40 |
| 2 | 0:30 | 500 | 50 | 1 | 40 |
| 3 | 0:30 | 100 | 80 | 1 | 40 |
| 4 | 1:30 | 750 | 80 | 1 | 40 |
| 5 | 1:00 | 800 | 135 | 2.7 | 40 |
| 6 | variable | 125 | 135 | 2.7 | 40 |
| 7 | 10 | 0 | 50 | 1 | 0 |

### Example 2

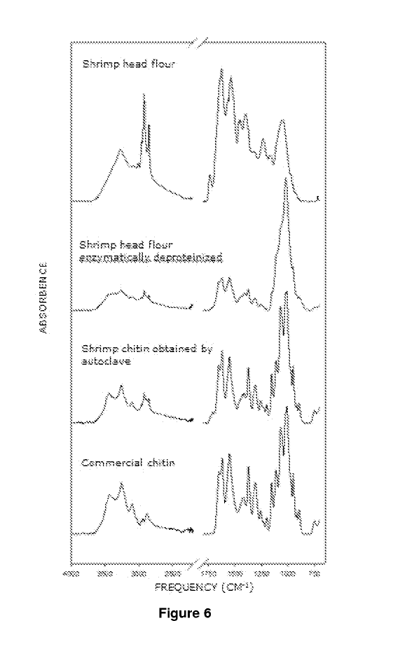

Process for obtaining chitin from shellfish waste by microwave with the addition of lactic acid, such as described below: Place a mixture of shrimp waste (shell) in a reactor together with an extracting agent (lactic acid 5M). The reactor is scheduled to raise the temperature in six stages to reach the temperature and pressure conditions described in Table 2. After the microwave irradiation process, the suspension is being filtered. In a second step of microwave irradiation the filtered material is placed with 5 M lactic acid at a ratio of 1:20 w/v and brought to the conditions described in Table 3. The retained material is considered as chitin and the latter is washed with distilled water under constant agitation at 150 rpm to remove residual organic acids and salts. Chitin is analyzed by infrared spectroscopy by Fourier transforms. FIG. 6 shows that the material obtained is chitin (curve at the top of the chart) compared to a commercial chitin (curve near the axis of the abscissas).

TABLE 2
Programming of pressurized microwave equipment
used in example 2, sequence 1.

| | Time | Power | Temperature | Pressure | Agitation |
|---|---|---|---|---|---|
| Ramp | (min) | (Watts) | (° C.) | (Bar) | (%) |
| 1 | 1:30 | 500 | 50 | 1 | 70 |
| 2 | 0:30 | 500 | 50 | 1 | 70 |
| 3 | 0:30 | 100 | 80 | 1 | 70 |
| 4 | 1:30 | 750 | 80 | 1 | 70 |
| 5 | 1:00 | 800 | 120 | 1.2 | 70 |
| 6 | variable | 120 | 120 | 1.2 | 70 |
| 7 | 10 | 0 | 50 | 1 | 0 |

### Example 3

Process for obtaining chitin from enzymatically deproteinized crustaceans waste combined with autoclave. The deproteinized material is mixed with lactic acid 0.4 M. The mixture is subjected to heating by autoclaving under the following conditions: 121° C. and 15 psi for 60 min. After the process, the chitin is washed and dried at 50° C. to a constant weight. The use of autoclaving or microwave assisted heating allows to demineralize materials containing chitin from a process of enzymatic deproteinization.

1-12. (canceled)

13. A process for obtaining chitin from crustaceans waste comprising the steps of:
mixing the crustaceans waste with a extracting agent;
heating said mixture during the mixing by using microwaves or autoclave to achieve the deproteinization/demineralization of the crustaceans waste in said mixture; and
filtering the chitin from said mixture.

14. The process of claim 13, wherein said extracting agent is an organic acid selected from a group consisting of citric acid, lactic acid and combinations thereof.

15. The process of claim 13, wherein said organic acid has a concentration of 0.5 to 5M.

16. The process of claim 13, wherein said extracting agent is distilled water.

17. The process of claims 13 and 14, wherein the crustaceans waste and the extracting agent in said mixture are in a ratio of 1:30 w/v when the extracting agent is citric acid or lactic acid of 1 M.

18. The process of claims 13 and 14, wherein the crustaceans waste and the extracting agent in said mixture are in a ratio of 1:20 w/v when the extracting agent is a lactic acid of 5M.

19. The process of claims 13 and 14, wherein the crustaceans waste and the extracting agent in said mixture are in a ratio of 1:30 when the extracting agent is a lactic acid of 0.5 to 1M.

20. The process of claims 13 and 14, wherein said step of heating said mixture by using microwaves and when is used citric acid of 1M or lactic acid of 0.5 to 1M in said mixture, includes the sub-steps of:
applying microwave irradiation during 1:30 minutes, with a power of 500 watts, a temperature of 50° C., a pressure of 1 bar, and an agitation of 40%;
applying microwave irradiation during 0:30 minutes, with a power of 500 watts, a temperature of 50° C., a pressure of 1 bar, and an agitation of 40%;
applying microwave irradiation during 0:30 minutes, with a power of 100 watts, a temperature of 80° C., a pressure of 1 bar, and an agitation of 40%;
applying microwave irradiation during 1:30 minutes, with a power of 750 watts, a temperature of 80° C., a pressure of 1 bar, and an agitation of 40%;
applying irradiation during 1:00 minutes, with a power of 800 watts, a temperature of 135° C., a pressure of 2.7 bar, and an agitation of 40%; and
applying microwave irradiation with a power of 125 watts, a temperature of 135° C., a pressure of 2.7 bar, and an agitation of 40%.

21. The process of claims 13 and 14, wherein said step of heating said mixture by using microwaves and when is used lactic acid of 5M in said mixture, includes the sub-steps of:
applying microwave irradiation during 1:30 minutes, with a power of 500 watts, a temperature of 50° C., a pressure of 1 bar, and an agitation of 70%;
applying microwave irradiation during 0:30 minutes, with a power of 500 watts, a temperature of 50° C., a pressure of 1 bar, and an agitation of 70%;
applying microwave irradiation during 0:30 minutes, with a power of 100 watts, a temperature of 80° C., a pressure of 1 bar, and an agitation of 70%;
applying microwave irradiation during 1:30 minutes, with a power of 750 watts, a temperature of 80° C., a pressure of 1 bar, and an agitation of 70%;
applying microwave irradiation during 1:00 minutes, with a power of 800 watts, a temperature of 120° C., a pressure of 1.2 bar, and an agitation of 70%; and
applying microwave irradiation with a power of 120 watts, a temperature of 120° C., a pressure of 1.2 bar, and an agitation of 70%.

22. The process of claim 13, wherein said step of filtering the chitin from said mixture is carried out until obtain a chitin with a relative humidity of 40%.

23. The process of claim 13, wherein said crustaceans waste is selected of a group consisting of shrimp shell of head, chest or abdomen, shrimp head flour, residuum of lobster, crab, and squid.

24. The process of claim 13, wherein said step of heating said mixture by using autoclave is carried out to a temperature of 121° C. and a pressure of 15 psi during 60 min and includes the step of washing and drying the chitin at 50° C. to a constant weight.
